(19) United States
(12) Patent Application Publication
(10) Pub. No.: US 2002/0119263 A1
(43) Pub. Date: Aug. 29, 2002

(54) Radiation sensitive composition for color filters, production process therefor, color filter and color liquid crystal display element

(75) Inventor: Shigeru Abe, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: JSR CORPORATION, Tokyo (JP)

(21) Appl. No.: 10/084,149

(22) Filed: Feb. 28, 2002

(30) Foreign Application Priority Data
Feb. 28, 2001 (JP) 2001-054579

(51) Int. Cl. C09K 19/00; C08J 3/28; C08G 2/00; C08F 2/46

(52) U.S. Cl. 428/1.3; 522/6

(57) ABSTRACT

A process is provided for producing a radiation sensitive composition for color filters. The process comprises (1) dispersing a pigment (A) in a solution of an alkali-soluble resin (B) dissolved in a solvent (E) to form a pigment dispersion; and (2) adding and mixing a polyfunctional monomer (C) and a photopolymerization initiator (D) with said pigment dispersion to form the radiation sensitive composition. The color filter is useful for a color liquid crystal display element.

### FIELD OF THE INVENTION

The present invention relates to a process for producing a radiation sensitive composition for color filters and, more specifically, to a process for producing a radiation sensitive composition for color filters which is used to form a color filter such as a transmission or reflection color liquid crystal display element or a color image pick-up element, to the radiation sensitive composition, to a color filter formed from the composition and to a color liquid crystal display element having the color filter.

### DESCRIPTION OF THE PRIOR ART

In the prior art, in order to produce a color filter from a radiation sensitive composition, the radiation sensitive composition is applied to the surface of a substrate or a substrate having a desired light screening layer pattern formed thereon and dried, and the dried coating film is exposed to radiation in a desired pattern and developed to obtain pixels of each color.

However, the thus produced color filter has the following problems to be solved: (1) a residue and stain are readily produced on the substrate or the light screening layer of an unexposed portion during development, (2) the surface smoothness of pixels post-baked after development and the adhesion of the formed pixels to the substrate or light screening layer are insufficient, and (3) the physical properties of the coating film are poor. These phenomena tend to become more marked as the concentration of a pigment contained in the radiation sensitive composition increases. Particularly, the surface smoothness of the pixels deteriorates more as the concentration of the pigment increases, thereby making it difficult to achieve sufficient color strength required for a color filter.

### OBJECTS OF THE INVENTION

It is an object of the present invention to provide a process for producing a radiation sensitive composition for color filters which exhibits excellent developability even when it contains a pigment in a high concentration.

It is another object of the present invention to provide a process for producing a radiation sensitive composition for color filters which does not produce a residue and stain on the substrate and the light screening layer of an unexposed portion during development and can give pixels having excellent surface smoothness and excellent adhesion to the substrate and the light screening layer.

It is still another object of the present invention to provide a radiation sensitive composition for color filters, which has the above excellent characteristic properties.

It is a further object of the present invention to provide a color filter formed from the radiation sensitive composition for color filters of the present invention and a liquid crystal display element having the color filter.

Other objects and advantages of the present invention will become apparent from the following description.

### SUMMARY OF THE INVENTION

According to the present invention, firstly, the above objects and advantages of the present invention are attained by a process for producing a radiation sensitive composition for color filters, comprising the steps of:

(1) dispersing a pigment (A) in a solution of an alkali-soluble resin (B) dissolved in a solvent (E) to form a pigment dispersion; and

(2) adding and mixing a polyfunctional monomer (C) and a photopolymerization initiator (D) and optionally the alkali-soluble resin (A) and the solvent (E) with the above pigment dispersion to form a radiation sensitive composition comprising the pigment (A), alkali-soluble resin (B), polyfunctional monomer (C), photopolymerization initiator (D) and solvent (E).

According to the present invention, secondly, the above objects and advantages of the present invention are attained by a radiation sensitive composition for color filters which is produced by the process of the present invention.

According to the present invention, thirdly, the above objects and advantages of the present invention are attained by a color filter formed from the radiation sensitive composition for color filters of the present invention.

Finally, the above objects and advantages of the present invention are attained by a color liquid crystal display element having the color filter of the present invention.

### DETAILED DESCRIPTION OF THE PREFERRED EMBODIMENT

Preferable Embodiments of the Invention

The present invention will be described in detail hereinbelow.

(A) Pigment

The pigment in the present invention is not limited to a particular color and is suitably selected according to the application purpose of the obtained color filter. It may be either organic or inorganic.

Examples of the organic pigment include compounds classified as Pigments according to Color Index (C.I.; The Society of Dyers and Colourists), specifically compounds having the following color index (C.I.) numbers:

C.I. Pigment Yellow 83, C.I. Pigment Yellow 128, C.I. Pigment Yellow 138, C.I. Pigment Yellow 139, C.I. Pigment Yellow 150, C.I. Pigment Yellow 151, C.I. Pigment Yellow 152, C.I. Pigment Yellow 153, C.I. Pigment Yellow 154, C.I. Pigment Yellow 155, C.I. Pigment Yellow 156, C.I. Pigment Yellow 166, C.I. Pigment Yellow 168, C.I. Pigment Yellow 175 and C.I. Pigment Yellow 185;

C.I. Pigment Violet 19, C.I. Pigment Violet 23, C.I. Pigment Violet 29, C.I. Pigment Violet 32, C.I. Pigment Violet 36 and C.I. Pigment Violet 38;

C.I. Pigment Red 177, C.I. Pigment Red 202, C.I. Pigment Red 206, C.I. Pigment Red 207, C.I. Pigment Red 208, C.I. Pigment Red 209, C.I. Pigment Red 215, C.I. Pigment Red 216, C.I. Pigment Red 220, C.I. Pigment Red 224, C.I. Pigment Red 226, C.I. Pigment Red 242, C.I. Pigment Red 243, C.I. Pigment Red 245, C.I. Pigment Red 254, C.I. Pigment Red 255, C.I. Pigment Red 264 and C.I. Pigment Red 265;

C.I. Pigment Blue 15, C.I. Pigment Blue 15:3, C.I. Pigment Blue 15:4, C.I. Pigment Blue 15:6 and C.I. Pigment Blue 60;

C.I. Pigment Green 7 and C.I. Pigment Green 36; and

C.I. Pigment Black 1 and C.I. Pigment Black 7.

Examples of the inorganic pigment include titanium oxide, barium sulfate, calcium carbonate, zinc oxide, lead sulfate, yellow lead, zinc yellow, red iron oxide (III), cadmium red, ultramarine blue, iron blue, chromium oxide green, cobalt green, amber, titanium black, synthetic iron black and carbon black.

Since a color filter requires high-precision color development and heat resistance, organic pigments and carbon black which have high color developability and high heat resistance are preferred out of these pigments.

In the present invention, the above pigments may be used alone or in combination of two or more.

Further, in the present invention, a dye and a natural pigment may be used in combination of the pigment as required.

In the present invention, the pigment is dispersed in a solution of an alkali-soluble resin (B) to be described hereinafter dissolved in a solvent (E) to be described hereinafter in the step (1).

This step (1) may be carried out by (i) preparing a solution of the alkali-soluble resin (B) dissolved in the solvent (E) and mixing the pigment (A) with the solution to disperse it in the solution or by (ii) mixing together the alkali-soluble resin (B), the solvent (E) and the pigment (A) to disperse the pigment (A) in the solution of the alkali-soluble resin (B) dissolved in the solvent (E).

The amounts of the alkali-soluble resin (B) and the solvent (E) used in the step (1) may be all or part of their amounts required for obtaining the finally obtained radiation sensitive composition. In the latter case, the rest of the alkali-soluble resin (B) and the rest of the solvent (E) may be added in the step (2) to be described hereinafter.

In the present invention, the alkali-soluble resin used in the step (1) and the alkali-soluble resin added as required in the step (2) may be the same or different but the alkali-soluble resin used in the step (1) is preferably an alkali-soluble resin (I), alkali-soluble resin (II), alkali-soluble resin (III) or the like to be described hereinafter, more preferably an alkali-soluble resin (II) or alkali-soluble resin (III), particularly preferably an alkali-soluble resin (II) or alkali-soluble resin (III) whose macromonomer is at least one selected from the group consisting of a polymethyl methacrylate macromonomer and a poly(methyl methacrylate/2-hydroxyethyl methacrylate) macromonomer.

The solvent (E) used in the present invention will be described in detail hereinafter. Examples of the solvent (E) which is preferably used in the step (1) include ethylene glycol monomethyl ether acetate, propylene glycol monomethyl ether, propylene glycol monomethyl ether acetate, propylene glycol monoethyl ether acetate, diethylene glycol dimethyl ether, diethylene glycol methyl ethyl ether, cyclohexanone, 2-heptanone, 3-heptanone, ethyl 2-hydroxypropionate, ethyl 3-methoxypropionate, methyl 3-ethoxypropionate, ethyl 3-ethoxypropionate, 3-methyl-3-methoxybutyl propionate, n-butyl acetate, i-butyl acetate, n-amyl formate, i-amyl acetate, n-butyl propionate, ethyl butyrate, i-propyl butyrate, n-butyl butyrate and ethyl pyruvate.

In the present invention, the pigment (A) is dispersed in the solution of the alkali-soluble resin (B) dissolved in the solvent (E) in the step (1) to forma pigment dispersion.

Although the amount of the alkali-soluble resin (B) in the solution in the step (1) may be suitably selected as far as the pigment can be uniformly dispersed in the solution, it is preferably 30 to 500 parts by weight, more preferably 50 to 300 parts by weight, much more preferably 70 to 200 parts by weight based on 100 parts by weight of the pigment.

Although the amount of the solvent (E) in the step (1) may be suitably selected as far as the pigment can be uniformly dispersed in the solution, it is preferably 50 to 2,000 parts by weight, more preferably 100 to 1,000 parts by weight based on 100 parts by weight of the pigment.

By using the alkali-soluble resin (B) and the solvent (E) in the above ranges for the dispersion of the pigment, the pigment is well dispersed, a radiation sensitive composition having excellent adhesion to a substrate and a light screening layer is obtained, and pixels having excellent surface smoothness and the like can be formed.

A suitable means may be employed to disperse the pigment as far as the pigment can be uniformly dispersed in the solution. A dispersing device capable of pulverizing the pigment and finely dispersing the obtained pigment particles, such as a bead mill or sand mill, can be advantageously used.

For the dispersion of the pigment, the surface of each pigment particle may be modified with a polymer. The polymer for modifying the surface of the pigment particle is, for example, a polymer disclosed by JP-A8-259876 (the term “JP-A” as used herein means an “unexamined published Japanese patent application”),or a commercially available polymer or oligomer for dispersing pigments.

In the step (1) of dispersing a pigment in the present invention, the alkali-soluble resin (B) serves as a dispersant for the pigment and it is preferred from the viewpoints of the developability of the radiation sensitive composition and the physical properties of the coating film that a pigment dispersant (to be referred to as “another pigment dispersant” hereinafter) other than the alkali-soluble resin (B) should not be added. However, another pigment dispersant may be used according to circumstances.

Examples of the another pigment dispersant include polycarboxylic acid esters such as polyacrylic acid esters; (partial) amine salts, ammonium salts and alkylamine salts of a polycarboxylic acid such as polyacrylic acid; hydroxyl group-containing polycarboxylic acid esters such as hydroxyl group-containing polyacrylic acid esters, and modified products thereof; polyurethanes; unsaturated polyamides; polysiloxanes; long-chain polyaminoamidophosphoric acid salts; amides obtained from a reaction between a poly(lower alkyleneimine) and a polyester having a free carboxyl group, salts thereof, and commercially available products under the trade names of Disperbyk-101,-130, -140, -160, -161, -162, -163, -164, -165, -166, -170, -171, -182, -2000 and -2001 (of BYK Japan Co., Ltd.); EFKA-47,-47EA, -48, -49, -100, -400 and -450 (of EFKA CHEMICALS Co., Ltd.); Solsperse 5000, 12000, 13240, 13940, 17000, 20000, 24000GR, 27000 and 28000 (of Zeneka Co., Ltd.); and PB711 and PB821 (of Ajinomoto Co., Inc.).

As a pigment dispersant other than the above may be used a cationic, anionic, nonionic, amphoteric, silicone-based or fluorine-based surfactant.

Examples of the above surfactant include polyoxyethylene alkyl ethers such as polyoxyethylene lauryl ether, polyoxyethylene stearyl ether and polyoxyethylene oleyl ether; polyoxyethylene alkylphenyl ethers such as polyoxyethylene octylphenyl ether and polyoxyethylene nonylphenyl ether; polyethylene glycol diesters such as polyethylene glycol dilaurate and polyethylene glycol distearate; sorbitan fatty acid esters; fatty acid modified polyesters; tertiary amine modified polyurethanes; and polyethylene imines, and commercially available products under the trade names of KP (of Shin-Etsu Chemical Co., Ltd.), Polyflow (of Kyoeisha Kagaku Co., Ltd.), F Top (of Tokem Products Co., Ltd.), Megafac (of Dainippon Ink and Chemicals, Inc.), Florade (of Sumitomo 3M Limited) and Asahi Guard and Surflon (of Asahi Glass Co., Ltd.).

These pigment dispersants may be used alone or in combination of two or more.

A pigment derivative obtained by treating a pigment with an acid, base or polymer may be used in conjunction with the another pigment dispersant.

Examples of the pigment derivative include blue pigment derivatives and yellow pigment derivatives such as a copper phthalocyanine derivative.

These pigment derivatives may be used alone or in combination of two or more.

The total amount of the another pigment dispersant and pigment derivative is generally 50 parts or less by weight, preferably 30 parts or less by weight based on 100 parts by weight of the pigment.

In the present invention, the average particle diameter of the pigment dispersed as described above is preferably 0.01 to 1.0 μm, more preferably 0.05 to 0.5 μm.

(B) Alkali-Soluble Resin

Any alkali-soluble resin is acceptable as the alkali-soluble resin used in the present invention as far as it has sufficient alkali solubility and serves effectively as a dispersant and binder for the pigment (A). The alkali-soluble resin is preferably (I) a copolymer of an ethylenically unsaturated monomer having a carboxyl group, an N-substituted maleimide and another copolymerizable ethylenically unsaturated monomer (to be referred to as “alkali-soluble resin (I)” hereinafter), (II) a copolymer of an ethylenically unsaturated monomer having a carboxyl group, a macromonomer having an ethylenically unsaturated group at one terminal of the molecular chain of the macromonomer (to be simply referred to as “macromonomer” hereinafter) and another copolymerizable ethylenically unsaturated monomer (to be referred to as “alkali-soluble resin (II)” hereinafter), (III) a copolymer of an ethylenically unsaturated monomer having a carboxyl group, an N-substituted maleimide, macromonomer and another copolymerizable ethylenically unsaturated monomer (to be referred to as “alkali-soluble resin (III)” hereinafter), or the like.

In the alkali-soluble resin (I), alkali-soluble resin (II) and alkali-soluble resin (III), “another copolymerizable ethylenically unsaturated monomers” does not include an ethylenically unsaturated monomer having a carboxyl group, an N-substituted maleimide and a macromonomer.

Examples of the above ethylenically unsaturated monomer having a carboxyl group include monocarboxylic acids such as acrylic acid, methacrylic acid, crotonic acid, α-chloroacrylic acid, ethacrylic acid, cinammic acid, mono(2-acryloyloxyethyl) succinate, mono(2-methacryloyloxyethyl) succinate, mono(2-acryloyloxyethyl) phthalate, mono(2-methacryloyloxyethyl) phthalate, ω-carboxy-polycaprolactone monoacrylate and ω-carboxy-polycaprolactone monomethacrylate; dicarboxylic acids (anhydrides) such as maleic acid, maleic anhydride, fumaric acid, itaconic acid, itaconic anhydride, citraconic acid, citraconic anhydride and mesaconic acid; and polycarboxylic acids (anhydrides) having 3 or more carboxyl groups.

Out of these ethylenically unsaturated monomers having a carboxyl group, preferred are acrylic acid, methacrylic acid, mono(2-acryloyloxyethyl) succinate, mono(2-methacryloyloxyethyl) succinate, ω-carboxy-polycaprolactone monoacrylate and ω-carboxy-polycaprolactone monomethacrylate. The above ethylenically unsaturated monomers having a carboxyl group may be used alone or in combination of two or more.

Examples of the above N-substituted maleimide include N-(substituted)arylmaleimides such as N-phenylmaleimide, N-o-hydroxyphenylmaleimide, N-m-hydroxyphenylmaleimide, N-p-hydroxyphenylmaleimide, N-o-methylphenylmaleimide, N-m-methylphenylmaleimide, N-p-methylphenylmaleimide, N-o-methoxyphenylmaleimide, N-m-methoxyphenylmaleimide and N-p-methoxyphenylmaleimide, and N-cyclohexylmaleimide.

Out of these N-substituted maleimides, preferred are N-phenylmaleimide, N-p-hydroxyphenylmaleimide and N-cyclohexylmaleimide.

The above N-substituted maleimides may be used alone or in combination of two or more.

Examples of the molecular chain of a polymer in the macromonomer include molecular chains such as polystyrene, polymethyl acrylate, polymethyl methacrylate, poly-n-butyl acrylate, poly-n-butyl methacrylate, a copolymer of methyl acrylate/2-hydroxyethyl acrylate, a copolymer of methyl acrylate/2-hydroxyethyl methacrylate, a copolymer of methyl methacrylate/2-hydroxyethyl acrylate, a copolymer of methyl methacrylate/2-hydroxyethylmethacrylate, polycaprolactone, polyoxyethylene and polysiloxane.

The macromonomer can be synthesized by reacting a prepolymer having a suitable functional group at one terminal of the above molecular chain of the macromonomer with an ethylenically unsaturated compound having a complementary functional group reactive with the above functional group.

The above prepolymer having a functional group can be obtained by living anionic polymerization, living cationic polymerization, a reaction for modifying the terminal of a living polymer and synthesis of a telechelic polymer, and a polyaddition resin or polycondensation resin having a terminal functional group may be used as the above prepolymer.

The above ethylenically unsaturated compound having a complementary functional group may be suitably selected from ethylenically unsaturated carboxylic acids such as acrylic acid and methacrylic acid, acid chlorides of the ethylenically unsaturated carboxylic acids, derivatives such as aminoalkyl esters, hydroxyalkyl esters and glycidyl esters, p-aminostyrene, vinyl glycidyl ethers, allyl glycidyl ethers and p-vinylbenzyl glycidyl ethers according to the type of the functional group in the prepolymer.

Preferred examples of the macromonomer in the present invention include macromonomers having an ethylenically unsaturated group, preferably acryloyl group or methacryloyl group at one terminal of the molecular chain of polymethyl methacrylate (to be referred to as “polymethyl methacrylate macromonomers” hereinafter) and macromonomers having an ethylenically unsaturated group, preferably acryloyl group or methacryloyl group at one terminal of the molecular chain of a copolymer of methyl methacrylate/2-hydroxyethyl methacrylate (to be referred to as “poly(methyl methacrylate/2-hydroxyethyl methacrylate) macromonomers” hereinafter).

The above macromonomers may be used alone or in combination of two or more.

Examples of the above another copolymerizable ethylenically unsaturated monomer include aromatic vinyl compounds such as styrene, α-methylstyrene, o-vinyltoluene, m-vinyltoluene, p-vinyltoluene, p-chlorostyrene, o-methoxystyrene, m-methoxystyrene, p-methoxystyrene, indene, p-vinylbenzyl methyl ether and p-vinylbenzyl glycidyl ether; indenes (derivatives) such as indene and 1-methylindene; unsaturated carboxylic acid esters such as methyl acrylate, methyl methacrylate, ethyl acrylate, ethyl methacrylate, n-propyl acrylate, n-propyl methacrylate, i-propyl acrylate, i-propyl methacrylate, n-butyl acrylate, n-butyl methacrylate, i-butyl acrylate, i-butyl methacrylate, sec-butyl acrylate, sec-butyl methacrylate, t-butyl acrylate, t-butyl methacrylate, 2-hydroxyethyl acrylate, 2-hydroxyethyl methacrylate, 2-hydroxypropyl acrylate 2-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, phenyl acrylate, phenyl methacrylate, 2-methoxyethyl acrylate, 2-methoxyethyl methacrylate, methoxydiethylene glycol acrylate, methoxydiethylene glycol methacrylate, methoxytriethylene glycol acrylate, methoxytriethylene glycol methacrylate, glycerol monoacrylate and glycerol monomethacrylate; unsaturated carboxylic acid aminoalkyl esters such as 2-aminoethyl acrylate, 2-aminoethyl methacrylate, 2-dimethylaminoethyl acrylate, 2-dimethylaminoethyl methacrylate, 2-aminopropyl acrylate, 2-aminopropyl methacrylate, 3-aminopropyl acrylate and 3-aminopropyl methacrylate; unsaturated carboxylic acid glycidyl esters such as glycidyl acrylate and glycidyl methacrylate; carboxylic acid vinyl esters such as vinyl acetate, vinyl propionate, vinyl butyrate and vinyl benzoate; unsaturated ethers such as vinylmethyl ether, vinylethyl ether, allyl glycidyl ether and methallyl glycidyl ether; vinyl cyanide compounds such as acrylonitrile, methacrylonitrile, α-chloroacrylonitrile and vinylidene cyanide; unsaturated amides such as acrylamide, methacrylamide, α-chloroacrylamide, N-2-hydroxyethyl acrylamide and N-2-hydroxyethyl methacrylamide; and aliphatic conjugated dienes such as 1,3-butadiene, isoprene and chloroprene.

Out of the above copolymerizable ethylenically unsaturated monomers, preferred are styrene, methyl acrylate, methyl methacrylate, 2-hydroxyethyl acrylate, 2-hydroxyethyl methacrylate, benzyl acrylate, benzyl methacrylate, phenyl acrylate, phenyl methacrylate, glycerol monoacrylate and glycerol monomethacrylate.

The above copolymerizable ethylenically unsaturated monomers may be used alone or in combination of two or more.

Examples of the alkali-soluble resin (I) include a copolymer of methacrylic acid/N-phenylmaleimide/styrene/benzyl methacrylate, a copolymer of methacrylic acid/N-phenylmaleimide/styrene/phenyl methacrylate, a copolymer of methacrylic acid/mono(2-acryloyloxyethyl)succinate/N-phenylmaleimide/styrene/benzyl methacrylate, a copolymer of methacrylic acid/ω-carboxypolycaprolactone monoacrylate/N-phenylmaleimide/styrene/benzyl methacrylate and a copolymer of methacrylic acid/N-phenylmaleimide/styrene/benzyl methacrylate/glycerol monomethacrylate.

The ethylenically unsaturated monomer having a carboxyl group is copolymerized in the alkali-soluble resin (I) in an amount of preferably 5 to 50 wt %, more preferably 10 to 40 wt %. When the ethylenically unsaturated monomer having a carboxyl group is copolymerized in an amount of less than 5 wt %, the solubility in an alkali developer of the obtained radiation sensitive composition may lower and when the ethylenically unsaturated monomer is copolymerized in an amount of more than 50 wt %, the formed pixels may fall off from the substrate or the surfaces of the pixels may be roughened during development with an alkali developer.

The N-substituted maleimide is copolymerized in the alkali-soluble resin (I) in an amount of preferably 5 to 50 wt %, more preferably 10 to 40 wt %. When the N-substituted maleimide is copolymerized in an amount of less than 5 wt %, the heat resistance of the obtained pixels may lower and when the N-substituted maleimide is copolymerized in an amount of more than 50 wt %, the alkali solubility of the obtained copolymer may lower with the result that a residue and stain may be produced on the substrate or the light screening layer of an unexposed portion.

The weight average molecular weight (to be referred to as “Mw” hereinafter) of the alkali-soluble resin (I) is preferably 1,000 to 1,000,000, more preferably 2,000 to 500,000, much more preferably 3,000 to 100,000.

The alkali-soluble resin (I) containing monomers in the above ranges and the above Mw has excellent solubility in an alkali developer and gives a cured product having excellent physical properties. A radiation sensitive composition comprising this alkali-soluble resin (I) rarely contains an undissolved product after development with an alkali developer and hardly produces a stain and the film residue in a region other than a pixel-forming portion of the substrate. In addition, the pixels obtained from the composition do not dissolve in an alkali developer excessively, have excellent adhesion to the substrate and do not fall off from the substrate.

Illustrative examples of the alkali-soluble resin (II) include a copolymer of acrylic acid/benzyl methacrylate/polymethyl methacrylate macromonomer, a copolymer of acrylic acid/benzyl methacrylate/poly(methyl methacrylate/2-hydroxyethyl methacrylate) macromonomer, a copolymer of methacrylic acid/methyl acrylate/polymethyl methacrylate macromonomer/a copolymer of methacrylic acid/methyl acrylate/poly(methyl methacrylate/2-hydroxyethyl methacrylate) macromonomer, a copolymer of methacrylic acid/benzyl acrylate/polymethyl methacrylate macromonomer, a copolymer of methacrylic acid/benzyl acrylate/poly(methyl methacrylate/2-hydroxyethyl methacrylate) macromonomer, a copolymer of methacrylic acid/methyl methacrylate/polymethyl methacrylate macromonomer, a copolymer of methacrylic acid/methyl methacrylate/poly(methyl methacrylate/2-hydroxyethyl methacrylate) macromonomer, a copolymer of methacrylic acid/benzyl methacrylate/polymethyl methacrylate macromonomer, a copolymer of methacrylic acid/benzyl methacrylate/poly(methyl methacrylate/2-hydroxyethyl methacrylate) macromonomer, a copolymer of acrylic acid/2-hydroxyethyl methacrylate/benzyl methacrylate/polymethyl methacrylate macromonomer, a copolymer of acrylic acid/2-hydroxyethyl methacrylate/benzyl methacrylate/poly(methyl methacrylate/2-hydroxyethyl methacrylate) macromonomer, a copolymer of methacrylic acid/2-hydroxyethyl methacrylate/benzyl methacrylate/polymethyl methacrylate macromonomer and a copolymer of methacrylic acid/2-hydroxyethyl methacrylate/benzyl methacrylate/poly(methyl methacrylate/2-hydroxyethyl methacrylate) macromonomer.

The ethylenically unsaturated monomer having a carboxyl group is copolymerized in the alkali-soluble resin (II) in an amount of preferably 5 to 50 wt %, more preferably 10 to 40 wt %. When the ethylenically unsaturated monomer having a carboxyl group is copolymerized in an amount of less than 5 wt %, the solubility in an alkali developer of the obtained radiation sensitive composition may lower and when the ethylenically unsaturated monomer having a carboxyl group is copolymerized in an amount of more than 50 wt %, the formed pixels may fall off from the substrate or the surfaces of the pixels may be roughened during development with an alkali developer.

The macromonomer is copolymerized in the alkali-soluble resin (II) in an amount of preferably 5 to 50 wt %, more preferably 10 to 40 wt %. When the macromonomer is copolymerized in an amount of less than 5 wt %, the pigment dispersibility may lower and when the macromonomer is copolymerized in an amount of more than 50 wt %, the alkali solubility of the obtained copolymer may lower with the result that a residue and stain may be produced on the substrate or the light screening layer of an unexposed portion.

Mw of the alkali-soluble resin (II) is preferably 1,000 to 1,000,000, more preferably 2,000 to 500,000, much more preferably 3,000 to 100,000.

An alkali-soluble resin (II) containing copolimerized monomers in the above ranges and the above Mw has excellent solubility in an alkali developer and gives a cured product obtained therefrom having excellent physical properties. A radiation sensitive composition comprising this alkali-soluble resin (II) rarely contains an undissolved product after development with an alkali developer and hardly produces a stain and the film residue in a region other than a pixel-forming portion of the substrate. In addition, the pixels obtained from the composition do not dissolve in an alkali developer excessively, have excellent adhesion to the substrate and do not fall off from the substrate.

Illustrative examples of the alkali-soluble resin (III) include a copolymer of methacrylic acid/N-phenylmaleimide/styrene/benzyl methacrylate/polymethyl methacrylate macromonomer, a copolymer of methacrylic acid/N-phenylmaleimide/styrene/benzyl methacrylate/poly(methyl methacrylate/2-hydroxyethyl methacrylate) macromonomer, a copolymer of methacrylic acid/N-phenylmaleimide/styrene/phenyl methacrylate/polymethyl methacrylate macromonomer, a copolymer of methacrylic acid/N-phenylmaleimide/styrene/phenyl methacrylate/poly(methyl methacrylate/2-hydroxyethyl methacrylate) macromonomer, a copolymer of methacrylic acid/N-phenylmaleimide/styrene/2-hydroxyethyl methacrylate/benzyl methacrylate/polymethyl methacrylate macromonomer, a copolymer of methacrylic acid/N-phenylmaleimide/styrene/2-hydroxyethyl methacrylate/benzyl methacrylate/poly(methyl methacrylate/2-hydroxyethyl methacrylate) macromonomer, a copolymer of methacrylic acid/N-phenylmaleimide/styrene/2-hydroxyethyl methacrylate/phenyl methacrylate/polymethyl methacrylate macromonomer, a copolymer of methacrylic acid/N-phenylmaleimide/styrene/2-hydroxyethyl methacrylate/phenyl methacrylate/poly(methyl methacrylate/2-hydroxyethyl methacrylate) macromonomer, a copolymer of methacrylic acid/mono(2-acryloyloxyethyl)succinate/N-phenylmaleimide/styrene/benzyl methacrylate/polymethyl methacrylate macromonomer, a copolymer of methacrylic acid/mono(2-acryloyloxyethyl)succinate/N-phenylmaleimide/styrene/benzyl methacrylate/poly(methyl methacrylate/2-hydroxyethyl methacrylate) macromonomer, a copolymer of methacrylic acid/mono(2-acryloyloxyethyl)succinate/N-phenylmaleimide/styrene/phenyl methacrylate/polymethyl methacrylate macromonomer, a copolymer of methacrylic acid/mono(2-acryloyloxyethyl)succinate/N-phenylmaleimide/styrene/phenyl methacrylate/poly(methyl methacrylate/2-hydroxyethyl methacrylate) macromonomer, a copolymer of methacrylic acid/ω-carboxypolycaprolactone monoacrylate/N-phenylmaleimide/styrene/benzyl methacrylate/polymethyl methacrylate macromonomer, a copolymer of methacrylic acid/ω-carboxypolycaprolactone monoacrylate/N-phenylmaleimide/styrene/benzyl methacrylate/poly(methyl methacrylate/2-hydroxyethyl methacrylate) macromonomer, a copolymer of methacrylic acid/ω-carboxypolycaprolactone monoacrylate/N-phenylmaleimide/styrene/phenyl methacrylate/polymethyl methacrylate macromonomer, a copolymer of methacrylic acid/ω-carboxypolycaprolactone monoacrylate/N-phenylmaleimide, styrene/phenyl methacrylate/poly(methyl methacrylate/2-hydroxyethyl methacrylate) macromonomer, a copolymer of methacrylic acid/N-phenylmaleimide/styrene/benzyl methacrylate/glycerol monomethacrylate/polymethyl methacrylate macromonomer, a copolymer of methacrylic acid/N-phenylmaleimide/styrene/benzyl methacrylate/glycerol monomethacrylate/poly(methyl methacrylate/2-hydroxyethyl methacrylate) macromonomer, a copolymer of methacrylic acid/N-phenylmaleimide/styrene/phenyl methacrylate/glycerol monomethacrylate/polymethyl methacrylate macromonomer, a copolymer of methacrylic acid/N-phenylmaleimide/styrene/phenyl methacrylate/glycerol monomethacrylate/poly(methyl methacrylate/2-hydroxyethyl methacrylate) macromonomer, a copolymer of methacrylic acid/N-phenylmaleimide/styrene/benzyl methacrylate/polymethyl methacrylate macromonomer/poly(methyl methacrylate/2-hydroxyethyl methacrylate) macromonomer, a copolymer of methacrylic acid/N-phenylmaleimide/styrene/2-hydroxyethyl methacrylate/phenyl methacrylate/polymethyl methacrylate macromonomer/poly(methyl methacrylate/2-hydroxyethyl methacrylate) macromonomer, a copolymer of methacrylic acid/mono(2-acryloyloxyethyl)succinate/N-phenylmaleimide/styrene/benzyl methacrylate/polymethyl methacrylate macromonomer/poly(methyl methacrylate/2-hydroxyethyl methacrylate) macromonomer, a copolymer of methacrylic acid/ω-carboxypolycaprolactone monoacrylate/N-phenylmaleimide/styrene/benzyl methacrylate/polymethyl methacrylate macromonomer/poly(methyl methacrylate/2-hydroxyethyl methacrylate) macromonomer and a copolymer of methacrylic acid/N-phenylmaleimide/styrene/benzyl methacrylate/glycerol monomethacrylate/polymethyl methacrylate macromonomer/poly(methyl methacrylate/2-hydroxyethyl methacrylate) macromonomer.

The ethylenically unsaturated monomer having a carboxyl group in the alkali-soluble resin (III) is copolymerized in an amount of preferably 5 to 50 wt %, more preferably 10 to 40 wt %. When the ethylenically unsaturated monomer having a carboxyl group is copolymerized in an amount of less than 5 wt %, the solubility in an alkali developer of the obtained radiation sensitive composition may lower and when the ethylenically unsaturated monomer having a carboxyl group is copolymerized in an amount of more than 50 wt %, the formed pixels may fall off from the substrate or the surfaces of the pixels may be roughened during development with an alkali developer.

The N-substituted maleimide monomer in the alkali-soluble resin (III) is copolymerized in an amount of preferably 5 to 50 wt %, more preferably 10 to 40 wt %. When the N-substituted maleimide monomer is copolymerized in an amount of less than 5 wt %, the heat resistance of the obtained pixels may lower and when the N-substituted maleimide monomer is copolymerized in an amount of more than 50 wt %, the alkali solubility of the obtained copolymer may lower with the result that a residue and stain may be produced on the substrate or the light screening layer of an unexposed portion.

The macromonomer in the alkali-soluble resin (III) is copolymerized in an amount of preferably 5 to 50 wt %, more preferably 10 to 40 wt %. When the macromonomer is copolymerized in an amount of less than 5 wt %, the pigment dispersibility may lower and when the macromonomer is copolymerized in an amount of more than 50 wt %, the alkali solubility of the obtained copolymer may lower with the result that a residue and stain may be produced on the substrate or the light screening layer of an unexposed portion.

Mw of the alkali-soluble resin (III) is preferably 1,000 to 1,000,000, more preferably 2,000 to 500,000, much more preferably 3,000 to 100,000.

An alkali-soluble resin (III) containing monomers in the above ranges and the above Mw has excellent solubility in an alkali developer and gives a cured product obtained therefrom having excellent physical properties. A radiation sensitive composition comprising this alkali-soluble resin (III) rarely contains an undissolved product after development with an alkali developer and hardly produces a stain and the film residue in a region other than a pixel-forming portion of the substrate. In addition, the pixels obtained from the composition do not dissolve in an alkali developer excessively, have excellent adhesion to the substrate and do not fall off from the substrate.

The alkali-soluble resin in the present invention is more preferably the alkali-soluble resin (II) or the alkali-soluble resin (III), particularly preferably the alkali-soluble resin (II) or the alkali-soluble resin (III) whose macromonomer is at least one selected from the group consisting of a polymethyl methacrylate macromonomer and a poly(methyl methacrylate/2-hydroxyethyl methacrylate) macromonomer.

An alkali-soluble resin other than the above alkali-soluble resins (I) to (III) (to be referred to as “another alkali-soluble resin” hereinafter) is, for example, a copolymer of acrylic acid/benzyl acrylate, a copolymer of methacrylic acid/benzyl acrylate, a copolymer of acrylic acid/styrene/methyl acrylate, a copolymer of methacrylic acid/styrene/methyl acrylate, a copolymer of acrylic acid/styrene/benzyl acrylate, a copolymer of methacrylic acid/styrene/benzyl acrylate, a copolymer of acrylic acid/benzyl methacrylate, a copolymer of methacrylic acid/benzyl methacrylate, a copolymer of acrylic acid/styrene/methyl methacrylate, a copolymer of methacrylic acid/styrene/methyl methacrylate, a copolymer of acrylic acid/styrene/benzylmethacrylate, a copolymer of methacrylic acid/styrene/benzyl methacrylate, a copolymer of acrylic acid/2-hydroxyethyl methacrylate/benzyl methacrylate or a copolymer of methacrylic acid/2-hydroxyethyl methacrylate/benzyl methacrylate.

Mw of the another alkali-soluble resin is preferably 1,000 to 1,000,000, more preferably 2,000 to 500,000, much more preferably 3,000 to 100,000.

The amount of the another alkali-soluble resin in the present invention is preferably 50 wt % or less, more preferably 30 wt % or less based on the whole alkali-soluble resin (B).

In the present invention, a desired amount of the alkali-soluble resin (B) may be wholly or partially used in the step (1). When part of the desired amount is used, the rest of the alkali-soluble resin (B) is used in the subsequent step (2).

The amount of the alkali-soluble resin (B) in the present invention is preferably 30 to 500 parts by weight, more preferably 50 to 300 parts by weight based on 100 parts by weight of the pigment (A). When the alkali-soluble resin (B) is used in the above range, a radiation sensitive composition having excellent adhesion to the substrate and the light screening layer and excellent developability can be obtained.

(C) Polyfunctional Monomer

The polyfunctional monomer in the present invention is a monomer having two or more polymerizable unsaturated bonds. Examples of the polyfunctional monomer include diacrylates and dimethacrylates of alkylene glycols such as ethylene glycol and propylene glycol; diacrylates and dimethacrylates of polyalkylene glycols such as polyethylene glycol and polypropylene glycol; polyacrylates and polymethacrylates of polyhydric alcohols having 3 or more hydroxyl groups such as glycerin, trimethylolpropane, pentaerythritol and dipentaerythritol, and dicarboxylic acid modified products thereof; oligoacrylates and oligomethacrylates such as polyesters, epoxy resins, urethane resins, alkyd resins, silicone resins and spiran resins; diacrylates and dimethacrylates of both terminal hydroxylated polymers such as poly-1,3-butadiene, polyisoprene and polycaprolactone having a hydroxyl group at both terminals; and tris(2-acryloyloxyethyl)phosphate and tris(2-methacryloyloxyethyl)phosphate.

Out of these polyfunctional monomers, preferred are polyacrylates and polymethacrylates of polyhydric alcohols having 3 or more hydroxyl groups, and dicarboxylic acid modified products thereof, such as trimethylolpropane triacrylate, trimethylolpropane trimethacrylate, pentaerythritol triacrylate, pentaerythritol trimethacrylate, pentaerythritol tetraacrylate, pentaerythritol tetramethacrylate, dipentaerythritol pentaacrylate, dipentaerythritol pentamethacrylate, dipentaerythritol hexaacrylate, dipentaerythritol hexamethacrylate, and compounds represented by the following formulas (1) and (2).

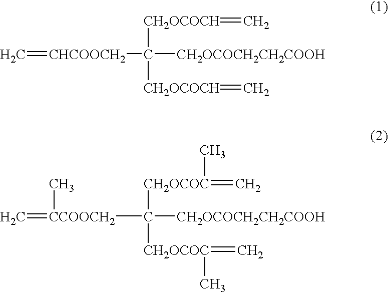

Out of these, particularly preferred are trimethylolpropane triacrylate, pentaerythritol triacrylate and dipentaerythritol hexaacrylate because they give a composition which provides pixels having high strength and excellent surface smoothness and hardly produces a stain and the film residue on the substrate and the light screening layer of an unexposed portion.

The above polyfunctional monomers may be used alone or in combination of two or more.

In the step (2), the polyfunctional monomer (C) is added to the pigment dispersion obtained in the step (1).

In the present invention, a monofunctional monomer may be used in conjunction with the above polyfunctional monomer according to circumstances in the step (2).

Examples of the monofunctional monomer include an ethylenically unsaturated monomer having a carboxyl group, an N-substituted maleimide and another copolymerizable ethylenically unsaturated monomer exemplified for the above alkali-soluble resin (B) and commercially available products such as M-5300 and M-5400 (trade name, manufactured by Toagosei Chemical Industry Co.).

These monofunctional monomers may be used alone or in combination of two or more.

The amount of the monofunctional monomer is preferably 90 wt % or less, more preferably 50 wt % or less based on the total of the polyfunctional monomer and the monofunctional monomer. When the amount of the monofunctional monomer is larger than 90 wt %, the strength and surface smoothness of the obtained pixels may become unsatisfactory.

The total amount of the polyfunctional monomer and the monofunctional monomer in the present invention is preferably 5 to 500 parts by weight, more preferably 20 to 300 parts by weight based on 100 parts by weight of the alkali-soluble resin (B). When the total amount is smaller than 5 parts by weight, the strength and surface smoothness of the pixels may lower and when the total amount is larger than 500 parts by weight, alkali developability may lower, and a stain and the film residue may be produced on the substrate or the light screening layer of an unexposed portion.

(D) Photopolymerization Initiator

The term “photopolymerization initiator” as used in the present invention refers to a compound which generates an active species capable of starting the polymerization of the above polyfunctional monomer, such as a radical, cation or anion, by decomposition or the cleavage of a bond upon exposure to radiation such as visible radiation, ultraviolet radiation, far ultraviolet radiation, electron beam or X-ray radiation.

Examples of the photopolymerization initiator include biimidazole-based compounds, benzoin-based compounds, acetophenone-based compounds, benzophenone-based compounds, α-diketone compounds, polynuclear quinone-based compounds, xanthone-based compounds and triazine-based compounds.

The above biimidazole-based compounds include, for example, 2,2′-bis(2-chlorophenyl)-4,4′,5,5′-tetrakis (4-ethoxycarbonylphenyl)-1,2′-biimidazole, 2,2′-bis(2-bromophenyl)-4,4′,5,540 -tetrakis (4-ethoxycarbonylphenyl)-1,2′-biimidazole, 2,2′-bis(2,4-dichlorophenyl)-4,4′,5,5′-tetraphenyl-1,2′-biimidazole, 2,2′-bis(2,4,6-trichlorophenyl)-4,4′,5,5′-tetraphenyl-1, 2′-biimidazole, 2,2′-bis(2,4-dibromophenyl)-4,4′,5,5′-tetraphenyl-1,2′-biimidazole and 2,2′-bis(2,4,6-tribromophenyl)-4,4′,5,5′-tetraphenyl-1,2′-biimidazole.

These biimidazole-based compounds have excellent solubility in a solvent and rarely produce foreign matter such as an undissolved product and precipitate. In addition, they have high sensitivity, fully promote a curing reaction by exposure with a small amount of energy, provide high contrast and are free from a curing reaction in an unexposed portion. Therefore, the obtained coating films after exposure are clearly divided into a cured portion insoluble in a developer and an uncured portion having high solubility in the developer, thereby making it possible to form a high-precision array of pixels which are not undercut and are arranged in a predetermined pattern.

The above benzoin-based compounds include, for example, benzoin, benzoin methyl ether, benzoin ethyl ether, benzoin i-propyl ether, benzoin i-butyl ether and methyl-2-benzoin benzoate.

The above acetophenone-based compounds include, for example, 2,2-dimethoxy-2-phenylacetophenone, 2-hydroxy-2-methyl-1-phenylpropane-1-one, 1-(4-i-propylphenyl)-2-hydroxy-2-methylpropane-1-one, 4-(2-hydroxyethoxy)phenyl-(2-hydroxy-2-propyl)ketone, 2,2-dimethoxyacetophenone, 2,2-diethoxyacetophenone, 2-methyl-(4-methylthiophenyl)-2-morpholino-1-propane-1-one, 2-benzyl-2-dimethylamino-1-(4-morpholinophenyl)butane-1-one, 1-hydroxycyclohexylphenyl ketone and 2,2-dimethoxy-1,2-diphenylethane-1-one.

The above benzophenone-based compounds include, for example, 4,4′-bis(dimethylamino)benzophenone and 4,4′-bis(diethylamino)benzophenone.

The above α-diketone-based compounds include, for example, diacetyl, dibenzoyl and methylbenzoyl formate.

The above polynuclear quinone-based compounds include, for example, anthraquinone, 2-ethylanthraquinone, 2-t-butylanthraquinone and 1,4-naphthoquinone.

The above xanthone-based compounds include, for example, xanthone, thioxanthone and 2-chlorothioxanthone.

The above triazine-based compounds include, for example, 1,3,5-tris(trichloromethyl)-s-triazine, 1,3-bis(trichloromethyl)-5-(2-chlorophenyl)-s-triazine, 1,3-bis(trichloromethyl)-5-(4-chlorophenyl)-s-triazine, 1,3-bis(trichloromethyl)-5-(2-methoxyphenyl)-s-triazine, 1,3-bis(trichloromethyl)-5-(4-methoxyphenyl)-s-triazine, 2-(2-furylethylidene)-4,6-bis(trichloromethyl)-s-triazine, 2-(4-methoxystyryl)-4,6-bis(trichloromethyl)-s-triazine, 2-(3,4-dimethoxystyryl)-4,6-bis(trichloromethyl)-s-triazine, 2-(4-methoxynaphthyl)-4,6-bis(trichloromethyl)-s-triazine, 2-(2-bromo-4-methylphenyl)-4,6-bis(trichloromethyl)-s-triazine and 2-(2-thiophenylethylidene)-4,6-bis(trichloromethyl)-s-triazine.

The above photopolymerization initiators may be used alone or in combination of two or more.

The photopolymerization initiator (D) is added to the pigment dispersion obtained in the step (1) together with the above polyfunctional monomer (C) in the step (2).

The amount of the photopolymerization initiator used in the present invention is preferably 0.01 to 200 parts by weight, more preferably 1 to 120 parts by weight, particularly preferably 1 to 100 parts by weight based on 100 parts by weight of the total of the polyfunctional monomer and the monofunctional monomer which is used according to circumstances. When the amount of the photopolymerization initiator is smaller than 0.01 part by weight, curing by exposure may not proceed thoroughly, thereby making it difficult to obtain an array of pixels arranged in a predetermined pattern. When the amount is larger than 200 parts by weight, the formed pixels may fall off from the substrate during development, and a stain and the film residue may be produced on the substrate or the light screening layer of an unexposed portion.

In the present invention, at least one of a sensitizer, a curing accelerator and a polymer photocrosslinking/sensitizing agent may be further used as required in conjunction with the above photopolymerization initiator.

(E) Solvent

Any solvent is acceptable to the solvent in the present invention as far as it disperses or dissolves the above components (A) to (D) constituting the radiation sensitive composition and additives to be described hereinafter, does not react with these components and has suitable volatility.

Examples of the solvent include (poly)alkylene glycol monoalkyl ethers such as ethylene glycol monomethyl ether, ethylene glycol monoethyl ether, ethylene glycol mono-n-propyl ether, ethylene glycol mono-n-butyl ether, diethylene glycol monomethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, propylene glycol mono-n-propyl ether, propylene glycol mono-n-butyl ether, dipropylene glycol monomethyl ether, dipropylene glycol monoethyl ether, dipropylene glycol mono-n-propyl ether, dipropylene glycol mono-n-butyl ether, tripropylene glycol monomethyl ether and tripropylene glycol monoethyl ether; (poly)alkylene glycol monoalkyl ether acetates such as ethylene glycol monomethyl ether acetate, ethylene glycol monoethyl ether acetate, diethylene glycol monomethyl ether acetate, diethylene glycol monoethyl ether acetate, propylene glycol monomethyl ether acetate and propylene glycol monoethyl ether acetate; other ethers such as diethylene glycol dimethyl ether, diethylene glycol methyl ethyl ether, diethylene glycol diethyl ether and tetrahydrofuran; ketones such as methyl ethyl ketone, cyclohexanone, 2-heptanone and 3-heptanone; lactic acid alkyl esters such as methyl 2-hydroxypropionate and ethyl 2-hydroxypropionate; other esters such as ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxyacetate, ethyl hydroxyacetate, methyl 2-hydroxy-3-methylbutanoate, 3-methyl-3-methoxybutyl acetate, 3-methyl-3-methoxybutyl propionate, ethyl acetate, n-propyl acetate, i-propyl acetate, n-butyl acetate, i-butyl acetate, n-amyl formate, i-amyl acetate, n-butyl propionate, ethyl butyrate, n-propyl butyrate, i-propyl butyrate, n-butyl butyrate, methyl pyruvate, ethyl pyruvate, n-propyl pyruvate, methyl acetoacetate, ethyl acetoacetate and ethyl 2-oxobutanoate; aromatic hydrocarbons such as toluene and xylene; and amides such as N-methylpyrrolidone, N,N-dimethylformamide and N,N-dimethylacetamide.

Out of these solvents, ethylene glycol monomethyl ether acetate, propylene glycol monomethyl ether, propylene glycol monomethyl ether acetate, propylene glycol monoethyl ether acetate, diethylene glycol dimethyl ether, diethylene glycol methylethylether, cyclohexanone, 2-heptanone, 3-heptanone, ethyl 2-hydroxypropionate, ethyl 3-methoxypropionate, methyl 3-ethoxypropionate, ethyl 3-ethoxypropionate, 3-methyl-3-methoxybutyl propionate, n-butyl acetate, i-butyl acetate, n-amyl formate, i-amyl acetate, n-butyl propionate, ethyl butyrate, i-propyl butyrate, n-butyl butyrate and ethyl pyruvate are preferred from the viewpoints of solubility, pigment dispersibility and coatability.

The above solvents may be used alone or in combination of two or more.

A desired amount of the solvent may be wholly or partially used in the step (1). When part of the amount is used in the step (1), the rest of the solvent is used in the step (2).

The solvent may be used in conjunction with a high-boiling solvent such as benzyl ethyl ether, dihexyl ether, acetonylacetone, isophorone, caproic acid, caprylic acid, 1-octanol, 1-nonanol, benzyl alcohol, benzyl acetate, ethyl benzoate, diethyloxalate, diethylmaleate, γ-butyrolactone, ethylene carbonate, propylene carbonate or ethylene glycol monophenyl ether acetate.

Out of these high-boiling solvents, γ-butyrolactone is preferred.

The above high-boiling solvents may be used alone or in combination of two or more.

Although the amount of the solvent in the present invention is not particularly limited, it is desirably such that the total amount of components contained in the composition excluding the solvent should be preferably 5 to 50 wt %, more preferably 10 to 40 wt % from the viewpoints of the coatability and stability of the obtained radiation sensitive composition.

Additives

The radiation sensitive composition for color filters obtained in the present invention may contain various additives as required.

The additives include an organic acid which serves to improve the solubility in an alkali developer of the radiation sensitive composition for color filters and to prevent an undissolved product from remaining after development.

The organic acid is preferably an aliphatic carboxylic acid or phenyl group-containing carboxylic acid having at least one carboxyl group in the molecule.

Examples of the above aliphatic carboxylic acid include monocarboxylic acids such as formic acid, acetic acid, propionic acid, butyric acid, valeric acid, pivalic acid, caproic acid, diethylacetic acid, enanthic acid and caprylic acid; dicarboxylic acids such as oxalic acid, malonic acid, succinic acid, glutaric acid, adipic acid, pimelic acid, suberic acid, azelaic acid, sebacic acid, brassylic acid, methylmalonic acid, ethylmalonic acid, dimethylmalonic acid, methylsuccinic acid, tetramethylsuccinic acid, cyclohexanedicarboxylic acid, itaconic acid, citraconic acid, maleic acid, fumaric acid and mesaconic acid; and tricarboxylic acids such as tricarballylic acid, aconitic acid and camphoronic acid.

The above phenyl group-containing carboxylic acid is an aromatic carboxylic acid having a carboxyl group directly bonded to a phenyl group or a carboxylic acid having a carboxyl group bonded to a phenyl group through a carbon chain.

Examples of the phenyl group-containing carboxylic acid include aromatic monocarboxylic acids such as benzoic acid, toluic acid, cuminic acid, hemellitic acid and mesitylenic acid; aromatic dicarboxylic acids such as phthalic acid, isophthalic acid and terephthalic acid; aromatic polycarboxylic acids having 3 or more carboxyl groups such as trimellitic acid, trimesic acid, mellophanic acid and pyromellitic acid; and others such as phenylacetic acid, hydroatropic acid, hydrocinnamic acid, mandelic acid, phenylsuccinic acid, atropic acid, cinnamic acid, cinnamylidenic acid, coumaric acid and umbellic acid.

Out of these organic acids, aliphatic dicarboxylic acids and aromatic dicarboxylic acids such as malonic acid, adipic acid, itaconic acid, citraconic acid, fumaric acid, mesaconic acid and phthalic acid are preferred from the viewpoints of alkali solubility, solubility in a solvent to be described hereinafter and the prevention of a stain and the film residue on the substrate or the light screening layer of an unexposed portion.

The above organic acids may be used alone or in combination of two or more.

The amount of the organic acid used is preferably 10 wt % or less, more preferably 5 wt % or less, particularly preferably 1 wt % or less based on the whole radiation sensitive composition. When the amount of the organic acid is larger than 10 wt %, the adhesion of the formed pixels to the substrate may deteriorate.

Additives other than the above organic acid include a dispersion aid such as a blue pigment derivative or yellow pigment derivative exemplified by copper phthalocyanine derivatives; filler such as glass or alumina; polymer compound such as polyvinyl alcohol, polyethylene glycolmonoalkyl ether or poly(fluoroalkylacrylate); nonionic, cationic or anionic surfactant; adhesion accelerator such as vinyltrimethoxysilane, vinyltriethoxysilane, vinyltris(2-methoxyethoxy)silane, N-(2-aminoethyl)-3-aminopropylmethyl dimethoxysilane, N-(2-aminoethyl)-3-aminopropyl trimethoxysilane, 3-aminopropyl triethoxysilane, 3-glycidoxypropyl trimethoxysilane, 3-glycidoxypropylmethyl dimethoxysilane, 2-(3,4-epoxycyclohexyl)ethyl trimethoxysilane, 3-chloropropylmethyl dimethoxysilane, 3-chloropropyl trimethoxysilane, 3-methacryloxypropyl trimethoxysilane or 3-mercaptopropyl trimethoxysilane; antioxidant such as 2,2-thiobis(4-methyl-6-t-butylphenol) or 2,6-di-t-butylphenol; ultraviolet absorber such as 2-(3-t-butyl-5-methyl-2-hydroxyphenyl)-5-chlorobenzotriazole or alkoxybenzophenone; cohesion inhibitor such as sodium polyacrylate; and thermocros slinking agent such as epoxy compound, melamine compound or bisazide compound.

The process for producing the radiation sensitive composition for color filters in the present invention comprises the step (1) of dispersing the pigment (A) in a solution of the alkali-soluble resin (B) dissolved in the solvent (E) and the step (2) of adding and mixing the polyfunctional monomer (C) and the photopolymerization initiator (D) and optionally the alkali-soluble resin (B) and the solvent (E) with the pigment dispersion obtained in the step (1) as described above.

The method of mixing together the components in the step (2) is not particularly limited and may be a commonly used method.

Method of Forming Color Filter

A description is subsequently given of the method of forming a color filter from the radiation sensitive composition of the present invention.

A light screening layer is first formed on the surface of a substrate to define a portion where pixels are to be formed, and a liquid radiation sensitive composition comprising, for example, a red pigment dispersed therein is applied to this substrate and prebaked to evaporate the solvent so as to form a coating film. Thereafter, this coating film is exposed to radiation through a photomask and developed with an alkali developer to dissolve and remove an unexposed portion of the coating film and then post-baked to form an array of red pixels arranged in a predetermined pattern.

Thereafter, liquid radiation sensitive compositions comprising green and blue pigments dispersed therein are applied, prebaked, exposed, developed and post-baked in the same manner as described above to form arrays of green pixels and blue pixels on the same substrate sequentially. A color filter having arrays of red, green and blue primary color pixels arranged on the substrate is thus obtained. The order of forming pixels patterns of these colors for forming a color filter is not limited to the above.

The substrate used to form the color filter is made from glass, silicon, polycarbonate, polyester, aromatic polyamide, polyamide-imide, polyimide or the like. The substrate may be subjected to a suitable pre-treatment such as chemical treatment with a silane coupling agent or the like, plasma treatment, ion plating, sputtering, gas-phase reaction or vacuum deposition as required.

To apply the liquid radiation sensitive composition to the substrate, rotational coating, cast coating, roll coating or the like may be suitably employed.

The thickness of the coating film after drying is preferably 0.1 to 10 μm, more preferably 0.2 to 5.0 μm, particularly preferably 0.2 to 3.0 μm.

The radiation used to fabricate the color filter is selected from visible radiation, ultraviolet radiation, far ultraviolet radiation, electron beams and X-radiation. It preferably has a wavelength of 190 to 450 nm.

The exposure amount of the radiation is preferably 10 to 10,000 mJ/cm².

The alkali developer is preferably an aqueous solution of sodium carbonate, sodium hydroxide, potassium hydroxide, tetramethylammonium hydroxide, choline, 1,8-diazabicyclo-[5.4.0]-7-undecene or 1,5-diazabicyclo-[4.3.0]-5-nonene.

The alkali developer may contain a water-soluble organic solvent such as methanol or ethanol and a surfactant in suitable amounts. The alkali developer is preferably washed away with water.

Development may be shower development, spray development, dip development or puddle development. As for development conditions, development is preferably carried out at normal temperature for 5 to 300 seconds.

The thus formed color filter is extremely useful for transmission and reflection type color liquid crystal display devices, color image pick-up elements, color sensors and the like.

### EXAMPLES

The following examples are provided for the purpose of further illustrating the present invention but are in no way to be taken as limiting.

### Comparative Example 1

A liquid radiation sensitive composition (g1) was prepared by mixing together 60 parts by weight of C.I. Pigment Green 36 and 30 parts by weight of C.I. Pigment Yellow 150 as the pigments (A), 90 parts by weight of a copolymer of methacrylic acid/2-hydroxyethyl methacrylate/benzyl methacrylate (weight ratio of 15/15/70, Mw=25,000) as the alkali-soluble resin (B), 60 parts by weight of dipentaerythritol hexaacrylate as the polyfunctional monomer (C), 50 parts by weight of 2-benzyl-2-dimethylamino-1-(4-morpholinophenyl)butane-1-one as the photopolymerization initiator (D) and 1,500 parts by weight of ethyl 3-ethoxypropionate as the solvent (E).

Thereafter, the liquid composition (g1) was applied to the surface of a soda glass substrate having a SiO₂ film for preventing the eluation of sodium ions formed on the surface with a spin coater and pre-baked at 80° C. for 10 minutes to form a 2.0 μm-thick coating film.

Subsequently, this substrate was cooled to room temperature and the coating film was exposed to 1,000 J/m² of ultraviolet radiation having wavelengths of 365 nm, 405 nm and 436 nm through a photomask using a high-pressure mercury lamp. The substrate was then immersed in a 0.04 wt % aqueous solution of potassium hydroxide at 23° C. for 1 minute to be developed, washed with ultra pure water and dried with air. Thereafter, the substratewas post-baked in a clean oven heated at 230° C. for 30 minutes to form a green striped color filter 15 μm×100 μm) on the substrate.

When the obtained color filter was observed through an optical microscope, a residue was observed on the substrate of an unexposed portion and the surface smoothness of the pixels was unsatisfactory.

When this color filter was observed using a projector, a stain was observed on the substrate of the unexposed portion. Further, when the surface of the substrate of the unexposed portion of this color filter was rubbed with Trecy (trade name, lens cleaner of Toray Industries, Inc.) impregnated with ethanol 10 times, the Trecy was colored green. In addition, adhesion between the pixels and the substrate was unsatisfactory.

### Example 1

A pigment dispersion was prepared by mixing together 60 parts by weight of C.I. Pigment Green 36 and 30 parts by weight of C.I. Pigment Yellow 150 as the pigments (A), 90 parts by weight of a copolymer of methacrylic acid/2-hydroxyethyl methacrylate/benzyl methacrylate/polymethyl methacrylate macromonomer (weight ratio of 15/15/60/10, Mw=20,000) as the alkali-soluble resin (B) and 200 parts by weight of propylene glycol monomethyl ether acetate as the solvent (E) by means of a bead mill.

Thereafter, a liquid radiation sensitive composition (G1) was prepared by mixing this pigment dispersion with 60 parts by weight of dipentaerythritol hexaacrylate as the polyfunctional monomer (C), 50 parts by weight of 2-benzyl-2-dimethylamino-1-(4-morpholinophenyl)butane-1-one as the photopolymerization initiator (D) and 1,500 parts by weight of ethyl 3-ethoxypropionate as the solvent (E).

Then, the liquid composition (G1) was applied to the surface of a soda glass substrate having a SiO₂ film for preventing the eluation of sodium ions formed on the surface with a spin coater and pre-baked at 80° C. for 10 minutes to form a 2.0 μm-thick coating film.

Subsequently, this substrate was cooled to room temperature and the coating film was exposed to 1,000 J/m² of ultraviolet radiation having wavelengths of 365 nm, 405 nm and 436 nm through a photomask using a high-pressure mercury lamp. The substrate was then immersed in a 0.04 wt % aqueous solution of potassium hydroxide at 23° C. for 1 minute to be developed, washed with ultra pure water and dried with air. Thereafter, the substrate was post-baked in a clean oven heated at 230° C. for 30 minutes to form a green striped color filter (15 μm×100 μm) on the substrate.

When the obtained color filter was observed through an optical microscope, no residue was observed on the substrate of an unexposed portion and the surface smoothness of the pixels was excellent.

When the color filter was observed using a projector, no stain was observed on the substrate of the unexposed portion.

Further, when the surface of the substrate of the unexposed portion of this color filter was rubbed with Trecy impregnated with ethanol 10 times, the Trecy was not colored. In addition, adhesion between the pixels and the substrate was excellent.

### Comparative Example 2

A liquid radiation sensitive composition (b1) was prepared by mixing together 90 parts by weight of C.I. Pigment Blue 15:6 as the pigment (A), 90 parts by weight of a copolymer of methacrylic acid/N-phenylmaleimide/styrene/benzyl methacrylate (weight ratio of 20/30/20/30, Mw=15,000) as the alkali-soluble resin (B), 60 parts by weight of dipentaerythritol hexaacrylate as the polyfunctional monomer (C), 50 parts by weight of 2-benzyl-2-dimethylamino-1-(4-morpholinophenyl)butane-1-one as the photopolymerization initiator (D) and 1,500 parts by weight of ethyl 3-ethoxypropionate as the solvent (E).

Thereafter, the liquid composition (b1) was applied to the surface of a soda glass substrate having a SiO₂ film for preventing the eluation of sodium ions formed on the surface with a spin coater and pre-baked at 80° C. for 10 minutes to form a 2.0 μm-thick coating film.

Subsequently, this substrate was cooled to room temperature and the coating film was exposed to 1,000 J/m² of ultraviolet radiation having wavelengths of 365 nm, 405 nm and 436 nm through a photomask using a high-pressure mercury lamp. The substrate was then immersed in a 0.04 wt % aqueous solution of potassium hydroxide at 23° C. for 1 minute to be developed, washed with ultra pure water and dried with air. Thereafter, the substrate was post-baked in a clean oven heated at 230° C. for 30 minutes to form a blue striped color filter (15 μm×100 μm) on the substrate.

When the obtained color filter was observed through an optical microscope, a residue was observed on the substrate of an unexposed portion and the surface smoothness of the pixels was unsatisfactory.

When the color filter was observed using a projector, a stain was observed on the substrate of the unexposed portion.

Further, when the surface of the substrate of the unexposed portion of this color filter was rubbed with Trecy impregnated with ethanol 10 times, the Trecy was colored blue. In addition, adhesion between the pixels and the substrate was unsatisfactory.

### Example 2

A pigment dispersion was prepared by mixing together 90 parts by weight of C.I. Pigment Blue 15:6 as the pigment (A), 90 parts by weight of a copolymer of methacrylic acid/N-phenylmaleimide/styrene/benzyl methacrylate/polymethyl methacrylate macromonomer (weight ratio of 20/30/20/15/15, Mw=15,000) as the alkali-soluble resin (B) and 200 parts by weight of propylene glycol monomethyl ether acetate as the solvent (E) by means of a bead mill.

Thereafter, a liquid radiation sensitive composition (B1) was prepared by mixing this pigment dispersion with 60 parts by weight of dipentaerythritol hexaacrylate as the polyfunctional monomer (C), 50 parts by weight of 2-benzyl-2-dimethylamino-1-(4-morpholinophenyl)butane-1-one as the photopolymerization initiator (D) and 1,500 parts by weight of ethyl 3-ethoxypropionate as the solvent (E).

Then, the liquid composition (B1) was applied to the surface of a soda glass substrate having a SiO₂ film for preventing the eluation of sodium ions formed on the surface with a spin coater and pre-baked at 80° C. for 10 minutes to form a 2.0 μm-thick coating film.

Subsequently, this substrate was cooled to room temperature and the coating film was exposed to 1,000 J/m² of ultraviolet radiation having wavelengths of 365 nm, 405 nm and 436 nm through a photomask using a high-pressure mercury lamp. The substrate was then immersed in a 0.04 wt % aqueous solution of potassium hydroxide at 23° C. for 1 minute to be developed, washed with ultra pure water and dried with air. Thereafter, the substrate was post-baked in a clean oven heated at 230° C. for 30 minutes to form a blue striped color filter (15 μm×100 μm) on the substrate.

When the obtained color filter was observed through an optical microscope, no residue was observed on the substrate of an unexposed portion and the surface smoothness of the pixels was excellent.

When the color filter was observed using a projector, no stain was observed on the substrate of the unexposed portion.

Further, when the surface of the substrate of the unexposed portion of this color filter was rubbed with Trecy impregnated with ethanol 10 times, the Trecy was not colored. In addition, adhesion between the pixels and the substrate was excellent.

### Comparative Example 3

A liquid radiation sensitive composition (r1) was prepared by mixing together 100 parts by weight of C.I. Pigment Red 177 as the pigment (A), 90 parts by weight of a copolymer of methacrylic acid/N-phenylmaleimide/styrene/benzyl methacrylate/glycerol monomethacrylate (weight ratio of 15/25/15/35/10, Mw=28,000) as the alkali-soluble resin (B), 60 parts by weight of dipentaerythritol hexaacrylate as the polyfunctional monomer (C), 10 parts by weight of 2,2′-bis(2,4-dichlorophenyl)-4,4′,5,5′-tetraphenyl-1,2′-biimidazole, 10 parts by weight of 4,4′-bis(diethylamino)benzophenone and 50 parts by weight of 2-benzyl-2-dimethylamino-1-(4-morpholinophenyl)butane-1-one as the photopolymerization initiators (D) and 1,000 parts by weight of ethyl 3-ethoxypropionate as the solvent (E).

Thereafter, the liquid composition (r1) was applied to the surface of a soda glass substrate having a SiO₂ film for preventing the eluation of sodium ions formed on the surface with a spin coater and pre-baked at 110° C. for 3 minutes to form a 2.0 μm-thick coating film.

Subsequently, this substrate was cooled to room temperature and the coating film was exposed to 1,000 J/m² of ultraviolet radiation having wavelengths of 365 nm, 405 nm and 436 nm through a photomask using a high-pressure mercury lamp. The substrate was then immersed in a 0.04 wt % aqueous solution of potassium hydroxide at 23° C. for 1 minute to be developed, washed with ultra pure water and dried with air. Thereafter, the substrate was post-baked in a clean oven heated at 230° C. for 30 minutes to form a red striped color filter (15 μm×100 μm) on the substrate.

When the obtained color filter was observed through an optical microscope, a residue was observed on the substrate of an unexposed portion and the surface smoothness of the pixels was unsatisfactory.

When the color filter was observed using a projector, a stain was observed on the substrate of the unexposed portion.

Further, when the surface of the substrate of the unexposed portion of this color filter was rubbed with Trecy impregnated with ethanol 10 times, the Trecy was colored red. In addition, adhesion between the pixels and the substrate was unsatisfactory.

### Example 3

A pigment dispersion was prepared by mixing together 100 parts by weight of C.I. Pigment Red 177 as the pigment (A), 90 parts by weight of a copolymer of methacrylic acid/N-phenylmaleimide/styrene/benzyl methacrylate/glycerol monomethacrylate (weight ratio of 15/25/15/35/10, Mw=28,000) as the alkali-soluble resin (B) and 200 parts by weight of propylene glycol monomethyl ether acetate as the solvent (E) by means of a bead mill.

Thereafter, a liquid radiation sensitive composition (R1) was prepared by mixing this pigment dispersion with 60 parts by weight of dipentaerythritol hexaacrylate as the polyfunctional monomer (C), 50 parts by weight of 2-benzyl-2-dimethylamino-1-(4-morpholinophenyl)butane-1-one as the photopolymerization initiator (D) and 1,500 parts by weight of ethyl 3-ethoxypropionate as the solvent (E).

Then, the liquid composition (RI) was applied to the surface of a soda glass substrate having a SiO₂ film for preventing the eluation of sodium ions formed on the surface with a spin coater and pre-baked at 110° C. for 3 minutes to form a 2.0 μm-thick coating film.

Subsequently, this substrate was cooled to room temperature and the coating film was exposed to 1,000 J/m² of ultraviolet radiation having wavelengths of 365 nm, 405 nm and 436 nm through a photomask using a high-pressure mercury lamp. The substrate was then immersed in a 0.04 wt % aqueous solution of potassium hydroxide at 23° C. for 1 minute to be developed, washed with ultra pure water and dried with air. Thereafter, the substrate was post-baked in a clean oven heated at 230° C. for 30 minutes to form a red striped color filter (15 μm×100 μm) on the substrate.

When the obtained color filter was observed through an optical microscope, no residue was observed on the substrate of an unexposed portion and the surface smoothness of the pixels was excellent.

When the color filter was observed using a projector, no stain was observed on the substrate of the unexposed portion.

Further, when the surface of the substrate of the unexposed portion of this color filter was rubbed with Trecy impregnated with ethanol 10 times, the Trecy was not colored. In addition, adhesion between the pixels and the substrate was excellent.

### Example 4

A pigment dispersion was prepared by mixing together 90 parts by weight of C.I. Pigment Blue 15:6 as the pigment (A), 90 parts by weight of a copolymer of methacrylic acid/N-phenylmaleimide/styrene/benzyl methacrylate/polymethyl methacrylate macromonomer/poly(methyl methacrylate/2-hydroxyethyl methacrylate) macromonomer (weight ratio of 20/30/20/10/10/10, Mw=20,000) as the alkali-soluble resin (B) and 200 parts by weight of propylene glycol monomethyl ether acetate as the solvent (E) by means of a bead mill.

Thereafter, a liquid radiation sensitive composition (B2) was prepared by mixing this pigment dispersion with 60 parts by weight of dipentaerythritol hexaacrylate as the polyfunctional monomer (C), 50 parts by weight of 2-benzyl-2-dimethylamino-1-(4-morpholinophenyl)butane-1-one as the photopolymerization initiator (D) and 1,500 parts by weight of ethyl 3-ethoxypropionate as the solvent (E).

Then, the liquid composition (B2) was applied to the surface of a soda glass substrate having a SiO₂ film for preventing the eluation of sodium ions formed on the surface with a spin coater and pre-baked at 80° C. for 10 minutes to form a 2.0 μm-thick coating film.

Subsequently, this substrate was cooled to room temperature and the coating film was exposed to 1,000 J/m² of ultraviolet radiation having wavelengths of 365 nm, 405 nm and 436 nm through a photomask using a high-pressure mercury lamp. The substrate was then immersed in a 0.04 wt % aqueous solution of potassium hydroxide at 23° C. for 1 minute to be developed, washed with ultra pure water and dried with air. Thereafter, the substrate was post -baked in a clean oven heated at 230° C. for 30 minutes to form a blue striped color filter (15 μm×100 μm) on the substrate.

When the obtained color filter was observed through an optical microscope, no residue was observed on the substrate of an unexposed portion and the surface smoothness of the pixels was excellent.

When the color filter was observed using a projector, no stain was observed on the substrate of the unexposed portion.

Further, when the surface of the substrate of the unexposed portion of this color filter was rubbed with Trecy impregnated with ethanol 10 times, the Trecy was not colored. In addition, adhesion between the pixels and the substrate was excellent.

### Comparative Example 4

A pigment dispersion was prepared by mixing together 60 parts by weight of C.I. Pigment Green 36 and 30 parts by weight of C.I. Pigment Yellow 150 as the pigments (A), 30 parts by weight of a polyethyleneimine-based copolymer (trade name of Solsperse, manufactured by Zeneka Co., Ltd.) as the alkali-soluble resin (B) and 200 parts by weight of methoxypropyl acetate as the solvent (E).

Thereafter, a liquid radiation sensitive composition was prepared by mixing this pigment dispersion with 60 parts by weight a copolymer of methacrylic acid/benzyl methacrylate/2-hydroxyethyl methacrylate/polymethyl methacrylate macromonomer (weight ratio of 15/60/15/10, Mw=25,000) as the alkali-soluble resin (B), 60 parts by weight of dipentaerythritol hexaacrylate as the polyfunctional monomer (C), 50 parts by weight of 2-benzyl-2-dimethylamino-1-(4-morpholinophenyl)butane-1-one as the photopolymerization initiator (D) and 1,500 parts by weight of ethyl 3-ethoxypropionate as the solvent (E).

Then, the liquid composition was applied to the surface of a soda glass substrate having a SiO₂ film for preventing the eluation of sodium ions formed on the surface with a spin coater and pre-baked at 80° C. for 10 minutes to form a 2.0 μm-thick coating film.

Subsequently, this substrate was cooled to room temperature and the coating film was exposed to 1,000 J/m² of ultraviolet radiation having wavelengths of 365 nm, 405 nm and 436 nm through a photomask using a high-pressure mercury lamp. The substrate was then immersed in a 0.04 wt % aqueous solution of potassium hydroxide at 23° C. for 1 minute to be developed, washed with ultra pure water and dried with air. Thereafter, the substrate was post-baked in a clean oven heated at 230° C. for 30 minutes to form a green striped color filter on the substrate.

When the obtained color filter was observed through an optical microscope, a residue was observed on the substrate and the light screening layer of an unexposed portion and the surface roughness of the pixel pattern was high. When the color filter was observed using a projector, a stain was observed on the substrate and the light screening layer of the unexposed portion. Further, when the surface of the substrate of the unexposed portion of this color filter was rubbed with Trecy impregnated with ethanol 10 times, the Trecy was colored green. In addition, the adhesion of a fine pattern having a line width of 30 μm or less was poor.

### Comparative Example 5

A pigment dispersion was prepared by mixing together 90 parts by weight of C.I. Pigment Blue 15:6 as the pigment (A), 30 parts by weight of a novolak resin having a weight average molecular weight of 10,000 as the alkali-soluble resin (B) and 200 parts by weight of methoxypropyl acetate as the solvent (E).

Thereafter, a liquid radiation sensitive composition was prepared by mixing this pigment dispersion with 60 parts by weight of a copolymer of N-phenylmaleimide/methacrylic acid/styrene/benzyl methacrylate (weight ratio of 30/20/20/30, Mw=25,000) as the alkali-soluble resin (B), 60 parts by weight of dipentaerythritol hexaacrylate as the polyfunctional monomer (C), 50 parts by weight of 2-benzyl-2-dimethylamino-1-(4-morpholinophenyl)butane-1-one as the photopolymerization initiator (D) and 1,500 parts by weight of ethyl 3-ethoxypropionate as the solvent (E).

Then, the liquid composition was applied to the surface of a soda glass substrate having a SiO₂ film for preventing the eluation of sodium ions formed on the surface with a spin coater and pre-baked at 80° C. for 10 minutes to form a 2.0 μm-thick coating film.

Subsequently, this substrate was cooled to room temperature and the coating film was exposed to 1,000 J/m² of ultraviolet radiation having wavelengths of 365 nm, 405 nm and 436 nm through a photomask using a high-pressure mercury lamp. The substrate was then immersed in a 0.04 wt % aqueous solution of potassium hydroxide at 23° C. for 1 minute to be developed, washed with ultra pure water and dried with air. Thereafter, the substrate was post-baked in a clean oven heated at 230° C. for 30 minutes to form a blue striped color filter on the substrate.

When the obtained color filter was observed through an optical microscope, a residue was observed on the substrate and the light screening layer of an unexposed portion and the surface roughness of the pixel pattern was high. When the color filter was observed using a projector, a stain was observed on the substrate and the light screening layer of the unexposed portion. Further, when the surface of the substrate of the unexposed portion of this color filter was rubbed with Trecy impregnated with ethanol 10 times, the Trecy was colored blue. In addition, the adhesion of a fine pattern having a line width of 30 μm or less was poor.

The radiation sensitive composition for color filters of the present invention exhibits excellent developability even when it contains a pigment in a high concentration, does not produce a residue and stain on the substrate and the light screening layer of an unexposed portion during development, and can give pixels having excellent surface smoothness and excellent adhesion to the substrate and the light screening layer.

Therefore, the radiation sensitive composition for color filters of the present invention can be extremely advantageously used for the production of color filters including a color filter for color liquid crystal displays in the field of the electronic industry.

What is claimed is:

1. A process for producing a radiation sensitive composition for color filters, comprising the steps of:
(1) dispersing a pigment (A) in a solution of an alkali-soluble resin (B) dissolved in a solvent (E) to form a pigment dispersion; and
(2) adding and mixing a polyfunctional monomer (C) and a photopolymerization initiator (D) and optionally said alkali-soluble resin (A) and said solvent (E) with said pigment dispersion to form a radiation sensitive composition comprising said pigment (A), alkali-soluble resin (B), polyfunctional monomer (C), photopolymerization initiator (D) and solvent (E).

2. The process of claim 1, wherein said alkali-soluble resin (B) is an alkali-soluble copolymer of an ethylenically unsaturated monomer having a carboxyl group, an N-substituted maleimide and another copolymerizable ethylenically unsaturated monomer.

3. The process of claim 1, wherein said alkali-soluble resin (B) is an alkali-soluble copolymer of an ethylenically unsaturated monomer having a carboxyl group, a macromonomer having an ethylenically unsaturated group at one terminal of the molecular chain of the macromonomer and another copolymerizable ethylenically unsaturated monomer.

4. The process of claim 1, wherein said alkali-soluble resin (B) is an alkali-soluble copolymer of an ethylenically unsaturated monomer having a carboxyl group, an N-substituted maleimide, a macromonomer having an ethylenically unsaturated group at one terminal of the molecular chain of the macromonomer and another copolymerizable ethylenically unsaturated monomer.

5. The process of claim 3 or 4, wherein said macromonomer is at least one selected from the group consisting of a macromonomer having an ethylenically unsaturated group at one terminal of the molecular chain of polymethyl methacrylate and a macromonomer having an ethylenically unsaturated group at one terminal of the molecular chain of a copolymer of methyl methacrylate and 2-hydroxyethyl methacrylate.

6. A radiation sensitive composition for color filters produced by the process of claim 1.

7. A color filter formed from the radiation sensitive composition for color filters of claim 6.

8. A color liquid crystal display element having the color filter of claim 7.
